(19) United States
(12) Patent Application Publication
(10) Pub. No.: US 2019/0303654 A1
(43) Pub. Date: Oct. 3, 2019

(54) SYSTEM TO STRENGTHEN UNIQUENESS OF SELFIE FOR EXPRESSION-BASED AUTHENTICATION

(71) Applicant: CA, Inc., New York, NY (US)

(72) Inventors: Lyju Rappai VADASSERY, Mumbai (IN); Vikrant NANDAKUMAR, Bangalore (IN); Vijay Shashikant KULKARNI, Bangalore (IN)

(73) Assignee: CA, Inc.

(21) Appl. No.: 15/936,692

(22) Filed: Mar. 27, 2018

(51) Int. Cl. G06K 9/00; G06F 21/45

(52) U.S. Cl. CPC G06K 9/00288; G06K 9/00308; G06F 21/32; G06F 21/45; G06K 9/00255

(57) ABSTRACT

In accordance with the teachings of the present disclosure, devices and methods of setting a selfie for expression-based authentication that strengthens the uniqueness of the selfie are provided. The method includes prompting a user to submit a non-standard selfie to be used for authentication, wherein the non-standard selfie comprises a facial expression of the user that the user does not typically make in a photo. After receiving the non-standard selfie, the method includes determining whether an expression in the non-standard selfie meets a pre-defined required degree of uniqueness. In response to determining that the expression in the non-standard selfie meets the required degree of uniqueness, the non-standard selfie is set as an authentication password.

### BACKGROUND

The present disclosure relates to devices and methods for guiding the user to make a unique, non-standard facial expression while setting a selfie that complies with a minimum degree of uniqueness for authentication purposes.

Some authentication systems employ selfie-based verification of a user's identity. However, widespread use of social media has made it relatively easy for an attacker who has obtained a photo of the user to fool such an authentication system. An attacker can also hack into a mobile device and copy data files, including photos, from the device. Additional security measures, such as liveness checks and the use of an expression-based selfie, may not deter an attacker who is skilled in the use of image-editing software.

### BRIEF SUMMARY

According to an aspect of the present disclosure, a method includes steps of: prompting a user to submit a non-standard selfie to be used for authentication, wherein the non-standard selfie comprises a facial expression of the user that the user does not typically make in a photo; receiving the non-standard selfie; determining whether the facial expression in the non-standard selfie meets a pre-defined required degree of uniqueness; and in response to determining that the facial expression in the non-standard selfie meets the required degree of uniqueness, setting the non-standard selfie as an authentication password.

According to another aspect of the present disclosure, a mobile device has a processor and memory, and the mobile device is configured to perform operations including: prompting a user to submit a non-standard selfie; receiving the non-standard selfie; determining whether an expression in the non-standard selfie meets a required degree of uniqueness, wherein the required degree of uniqueness comprises a minimum variance; and in response to determining that the expression in the non-standard selfie meets the required degree of uniqueness, setting the non-standard selfie as an authentication password.

According to another aspect of the present disclosure, a non-transitory, computer-readable storage medium includes instructions that when executed by a computer, cause the computer to perform a method including steps of: prompting a user to submit a non-standard selfie; receiving the non-standard selfie; determining whether an expression in the non-standard selfie meets a required degree of uniqueness; and in response to determining that the expression in the non-standard selfie meets the required degree of uniqueness, setting the non-standard selfie as an authentication password.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIGS. 1a and 1b illustrate a mobile device positioned in accordance with the teachings of the present disclosure.

FIG. 2 illustrates a flow chart of a method, in accordance with the teachings of the present disclosure.

FIG. 3 illustrates a flow chart of a method, in accordance with the teachings of the present disclosure.

FIG. 4 illustrates an environment for setting a unique selfie as an authentication password in accordance with the teachings of the present disclosure.

FIG. 5 illustrates a server for determining whether a selfie meets a required degree of uniqueness in accordance with the teachings of the present disclosure.

FIG. 6 illustrates a server acting in accordance with the teachings of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to a broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

In view of the foregoing, a need has arisen for ways to improve the security of selfie-based authentication. For example, the facial expression made by a user while setting a selfie for authentication may be as unique as possible compared to expressions the user typically makes in selfies or photos. In one example, the uniqueness of the facial expression may be determined by whether the user has made that facial expression in any photo taken in the past, from the sources of photos of the user which the server can access.

Devices and methods disclosed herein may set and enforce a degree of uniqueness of the facial expression in a user's selfie, where the selfie is to be used for authentication. The degree of uniqueness is similar to the password strength characteristics that can be specified by an administrator. The present invention may include a centralized authentication server that guides a user to set a selfie with a non-standard or unique facial expression for authentication. An administrator may configure the required minimum degree of uniqueness. The present invention works like a software module that enforces password strength criteria. Such a module ensures that a user sets a password that, for example, includes at least 8 characters, contains a combination of uppercase and lowercase letters, contains at least 1 special character, etc. Along similar lines, the present invention ensures that a user sets an expression selfie for authentication purposes that is as unique as specified by the system.

The technique requires that while a user is taking the expression selfie, the user holds their mobile phone with the phone's screen pointed at the ceiling such that the user is looking down at the camera and that the distance between the user's face and the phone is such that the user's face fills the screen. These two guidelines may ensure that when the user uses the app to take a selfie for authentication, the scope for other users or cameras to see the user's facial expression is minimized. The system may then check for uniqueness of the expression selfie.

A client-side component or app may be implemented as a software module in a mobile app that is used for authentication or includes authentication features. The client-side component or app may also be a feature provided by an authentication module of a mobile operating system (OS). Face ID® provided by iOS is an example of this type of module. A server-side component or server directs the client-side component, tracks down other photos of the user, compares the expression selfie with the other photos of the user, and stores the expression selfie.

While configuring the system, an administrator may set the required degree of uniqueness. This may be a minimum variance, e.g., 20% or other suitable variance, between the expression selfie and the normal selfie and all other photos of the user that the system has access to. The present invention is focused on enabling the user to set a unique or non-standard expression selfie for authentication. A unique expression selfie involves the user making a facial expression that the user would not typically make in a selfie or photo. For example, if the user typically makes a winking face or is blowing a kiss in a photo, but does not normally make a puffed-out cheeks expression in photos, the user would use a puffed-out cheeks expression for the non-standard, expression selfie.

The administrator may set parameters for an activation flow (i.e., the process of setting the authentication selfie as the “password”) and for a transaction flow (i.e., using the selfie as the authentication “password”). For the activation flow, a minimum variance (e.g., 20% or other suitable variance) is set between the expression selfie and the normal selfie and all other photos of the user that the system is allowed to access. For the transaction flow, a maximum variance (e.g., 3% or other suitable variance) is set between the submitted expression selfie and the stored expression selfie.

An example method according to the present invention includes that an app on a mobile device may prompt the user to submit a normal selfie. In the normal selfie, the user is making their typical or most commonly used facial expression (such as a winking face or blowing a kiss, as described above). After the user submits a normal selfie, a liveness check may be conducted. A liveness check may require the user to blink after the initial photo or take some other action that indicates the proper user of the mobile device is the one submitting the selfie rather than an imposter using a picture of the proper user.

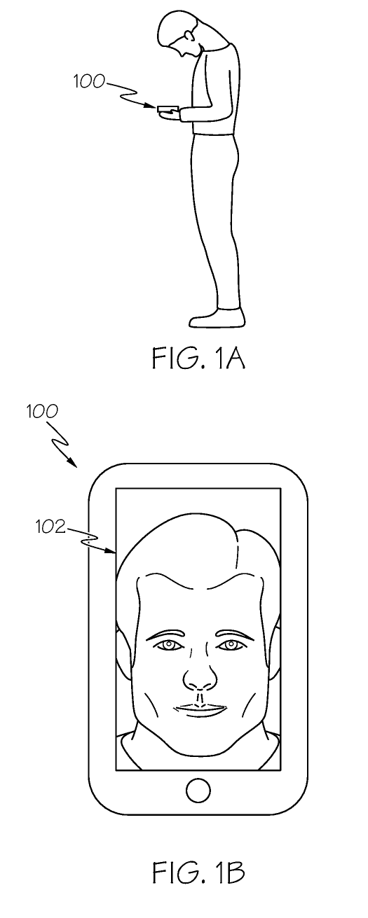

The app may then prompt the user to submit an expression selfie. The prompt may read “Make an expression that you'd never make in a photo” or other similar instruction to elicit a non-standard or unique facial expression from the user. While taking the expression selfie, the app requires the user to hold the phone with the screen pointed at the ceiling, so the user is looking down at the camera of the mobile device 100 (as shown in FIG. 1A) and from a distance such that the user's face fills the screen 102 of the mobile device 100 (as shown in FIG. 1B). This ensures that when the user uses the app to take photos for authentication the ability for other users or cameras to see the user's facial expression is minimized. Sensors (e.g., accelerometers, gyroscopes, or other suitable sensors for determining which way a mobile phone is pointing) present in the mobile phone may ensure the phone is being held in this manner before allowing the user to take the expression selfie.

The server may then check for uniqueness of the expression selfie. The server may determine whether the facial expression meets the uniqueness standard. The uniqueness standard may be set by the administrator. The server may access the user's photo galleries stored on the mobile phone (e.g., the Photos app on the iPhone), Facebook, Instagram, or other sources of photos of the user depending on which applications the system is given permission to access. Previously submitted expression selfies may also be stored on the system. The system may also perform a Google image search online, or another similar Internet image search, for the user's name. The system may then compare the expression selfie to normal selfies, previously submitted selfies, or the user's photo galleries stored on the mobile phone (e.g., the Photos app on the iPhone), Facebook, Instagram, or other sources of photos that the system is given permission to access. The system may perform these comparison steps by using an algorithm, such as the one used by Google's Reverse Image Search API. The administrator may set the required degree of uniqueness, which may be a minimum variance, such as 20% or other suitable variance, between the expression selfie and an expression in the normal selfie and facial expressions in all other photos of the user that the system has access to.

In response to determining that the expression does not meet the uniqueness standard, the server, through the app, may prompt the user to submit a different expression selfie. The server, through the app, may prompt the user to submit a different expression selfie for any of the following reasons: i) the expression selfie is not very different from the normal selfie because the user is making an expression that is not very different from his or her normal face; ii) the system compares the expression selfie with any selfie that has previously been submitted to the system and finds a previous photo that has a similar expression to the expression in the expression selfie; or iii) the system accesses the user's photo galleries stored on the mobile phone or stored in mobile applications and/or searches online to check whether the facial expression in the expression selfie is similar to the expression in any of the user's existing digital photos and the system finds a photo with a similar expression. In response to determining that the expression in the expression selfie meets the uniqueness standard (which may be specified by the administrator), the system sets the expression selfie as the user's “password” for authentication. As described above, a minimum degree of variance is used to determine whether the facial expression in the non-standard expression selfie is unique (i.e., different enough from other photos of the user, such that an imposter could not find a photo of the user making the same expression).

There may be an app on a user's mobile phone that is used for setting the unique expression-based selfie according to the present invention. This may also be an online service purely for authentication purposes or may be part of the mobile phone's operating system. Once set according to the present invention, the expression-based selfie can be used as an authentication “password” across different mobile applications once APIs are added to apps to make use of this selfie-based authentication.

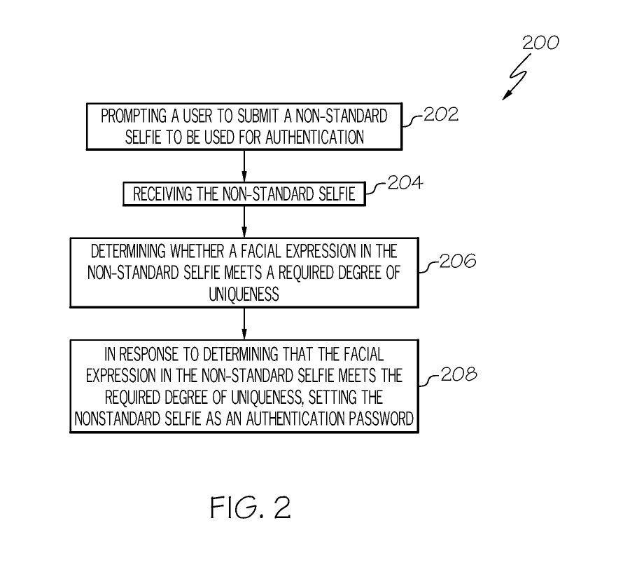

An example method 200 according to the present invention is depicted in FIG. 2. At step 202, a user is prompted to submit a non-standard selfie to be used for authentication. The non-standard selfie is received at step 204. At step 206, the system determines whether a facial expression in the non-standard selfie meets a required degree of uniqueness. As described above, the required degree of uniqueness may be a minimum variance between the facial expression in the non-standard selfie and the user's facial expression in other photos/selfies that the system can access. In response to determining that the facial expression in the non-standard selfie meets the required degree of uniqueness, the non-standard selfie is set as an authentication password at step 208.

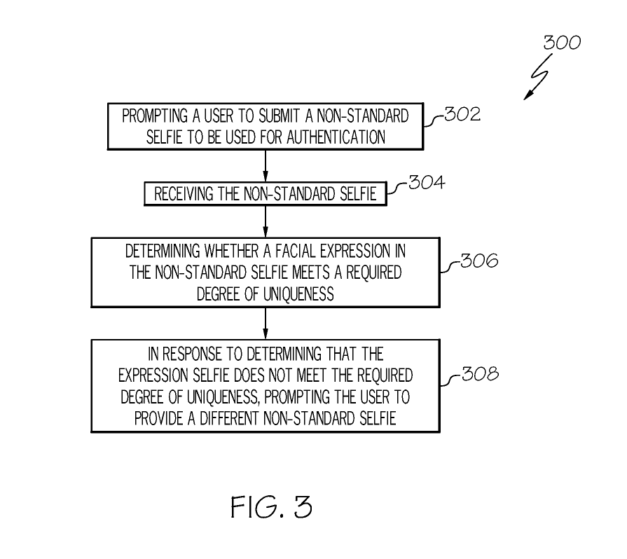

An example method 300 according to the present invention is depicted in FIG. 3. At step 302, a user is prompted to submit a non-standard selfie to be used for authentication. The non-standard selfie is received at step 304. At step 306, the system determines whether a facial expression in the non-standard selfie meets a required degree of uniqueness. As described above, the required degree of uniqueness may be a minimum variance between the facial expression in the non-standard selfie and the user's facial expression in other photos/selfies that the system can access. In response to determining that the facial expression in the non-standard selfie does not meet the required degree of uniqueness, the user is prompted to provide a different non-standard selfie at step 308.

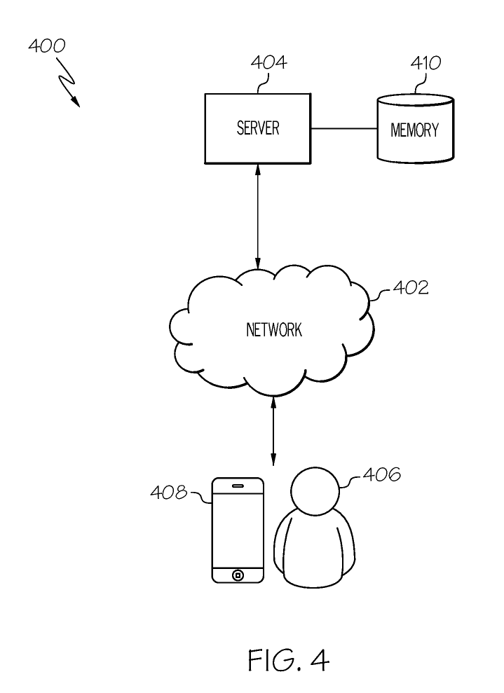

FIG. 4 illustrates an exemplary system 400 in which the subject matter of the disclosure can function. The system 400 generally includes a network 402 communicatively coupling server 404 to one or more client devices 408 and a memory 410. In the depicted embodiment, for example, system 400 includes a user 406 of a mobile device 408. As described above, the user 406 may submit a non-standard selfie to be used for authentication purposes to the server 404 via mobile device 408 over the network 402.

The network 402 generally refers to any interconnecting system capable of transmitting audio, video, signals, data, messages, or any combination of the preceding. Further, the network 402 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems. Network 402 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third generation partnership project (3GPP) standards, or other standards.

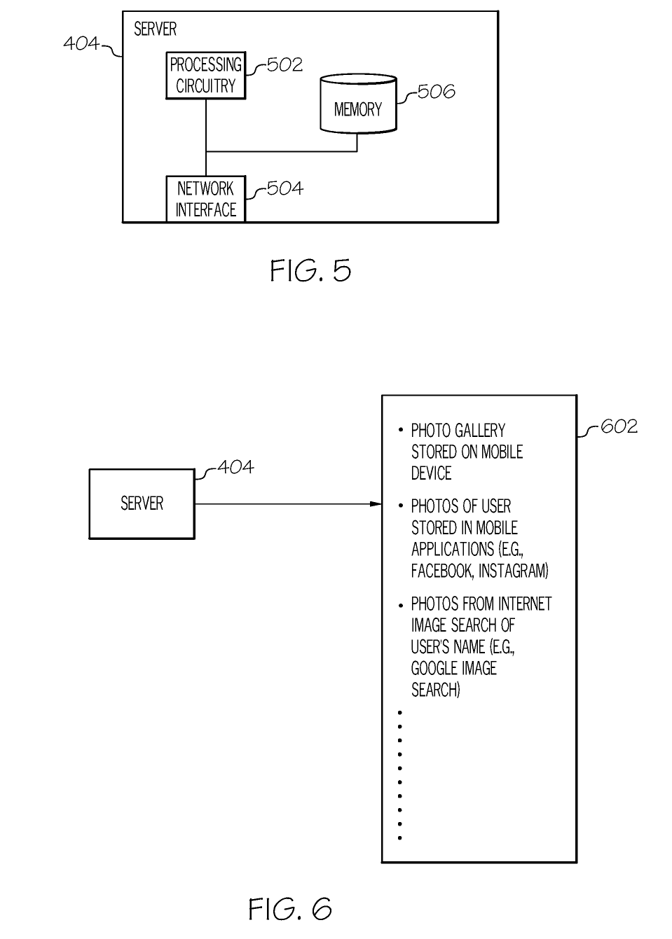

Client device 408 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the server 104 through the network 102. Further, client device 408 may employ any known operating systems such as MSDOS®, PC-DOS®, OS-2®, MAC-OS, or any other appropriate operating systems. In the depicted embodiment of FIG. 4, client device 408 is a mobile device, such as a smartphone. The smartphone itself may have a network interface, processing circuitry, and a memory similar to those described below with respect to server 404 in FIG. 5. The memory on the smartphone or other mobile device may store photos in the memory.

According to certain embodiments, server 404 may include a file server, a domain name server, a proxy server, a web server, a computer workstation, or any other device providing access to network 402. Further, the server 404 may use any appropriate operating system, such as MS-DOS®, MAC-OS®, WINDOWS®, UNIX, or any other operating system currently in existence or developed in the future. According to certain embodiments, server 404 operates as a central authentication server and stores selfies submitted by the user 406 in memory 410. According to certain embodiments, memory 410 may include storage media, such as hard disk drives, volatile or non-volatile memory, optical disk storage devices, or any other storage devices, including removable storage devices.

FIG. 5 illustrates a server 404 operating as a central authentication server according to a non-limiting embodiment of the present invention. As depicted, server 404 includes a processing circuitry 502, a network interface 504, and a system memory 506. The network interface 504 connects server 404 to network 402. The processing circuitry 502 may be utilized for the processing requirements of server 404. In certain embodiments, processing circuitry 502 may be operable to load instructions from a hard disk into memory 506 and execute those instructions.

Network interface 504 may refer to any suitable device capable of receiving an input, sending an output from server 404, performing suitable processing of the input or output or both, communicating with other devices, and so on. For example, the network interface 504 may include appropriate modem hardware, network interface card, and similar devices. Further, the software capabilities of the network interface 504 may include protocol conversion and data processing capabilities, to communicate through a LAN, WAN, or other communication system, allowing server 404 to communicate to other devices. Moreover, the network interface 504 may include one or more ports, conversion software, or both.

Processing circuitry 502 can be any suitable device capable of executing instructions to perform operations for server 404. Processing circuitry 502 may include microprocessors, microcomputers, microcontrollers, digital signal processors, central processing units, processing circuitry, state machines, logic circuitries, and/or any devices that manipulate signals based on operational instructions. For example, processing circuitry 502 may be any central processing unit (CPU), such as the Pentium processor, the Intel Centrino processor, and so on.

Further, the system memory 506 may be any suitable device capable of storing computer-readable data and instructions. For example, the system memory 506 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding. According to certain embodiments, memory 506 may store selfies taken by a user that are uploaded to the server and used as prior or past authentication “passwords” (i.e., previously submitted selfies).

Although server 404 is depicted as including only a single network interface 504, processing circuitry 502, and memory 506, these items may be present in multiple items, or combined items, as known in the art. It is also recognized that other embodiments may include the placement of one or more of these components elsewhere in server 404.

According to certain embodiments, server 404 may provide central authentication functions and may determine whether a non-standard selfie submitted by a user 406 meets a required degree of uniqueness, as described above.

FIG. 6 illustrates the server 404 accessing various sources of photos of the user 406 when acting as a central authentication server to determine whether a submitted selfie meets a required degree of uniqueness. As described above, the server 404 may compare the submitted non-standard expression selfie to other sources of photos 602 of the user 406 to determine if the required degree of uniqueness is met (e.g., a minimum variance in facial expressions between the non-standard selfie and other photos, including selfies, of the user). For example, the server 404 may access a photo gallery with selfies or other photos of the user 406 stored on the mobile device 408. The server 404 may also access selfies or other photos of the user 406 stored in mobile applications, such as Facebook and Instagram. The server 404 may also perform an internet search for images of the user, such as a Google image search. The system administrator may determine which sources of photos the server has access to for performing the comparison steps as described above to determine whether the required degree of uniqueness is met.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
prompting a user to submit a non-standard selfie to be used for authentication, wherein the non-standard selfie comprises a facial expression of the user that the user does not typically make in a photo;
receiving the non-standard selfie;
determining whether the facial expression in the non-standard selfie meets a pre-defined required degree of uniqueness; and
in response to determining that the facial expression in the non-standard selfie meets the required degree of uniqueness, setting the non-standard selfie as an authentication password.

2. The method of claim 1, further comprising:
prompting the user to submit a standard selfie; and
receiving the standard selfie from the user,
wherein determining whether the facial expression in the non-standard selfie meets the required degree of uniqueness comprises:
comparing the facial expression in the non-standard selfie to an expression in the standard selfie; and
determining a variance between the facial expression in the non-standard selfie and the expression in the standard selfie.

3. The method of claim 1, wherein determining whether the facial expression in the non-standard selfie meets the required degree of uniqueness comprises:
comparing the facial expression in the non-standard selfie to expressions in previously submitted selfies; and
determining a variance between the facial expression in the non-standard selfie and the expressions in the previously submitted selfies.

4. The method of claim 1, wherein determining whether the facial expression in the non-standard selfie meets the required degree of uniqueness comprises:
accessing at least one photo gallery containing pictures of the user;
comparing the facial expression in the non-standard selfie to expressions in the pictures of the user contained in the at least one photo gallery; and
determining a variance between the facial expression in the non-standard selfie and the expressions in the pictures of the user contained in the at least one photo gallery.

5. The method of claim 1, further comprising in response to determining that the facial expression in the non-standard selfie does not meet the required degree of uniqueness, prompting the user to provide a different non-standard selfie.

6. The method of claim 1, wherein a mobile device is configured to receive the non-standard selfie, and wherein prompting a user to submit a non-standard selfie comprises displaying instructions to the user to:
point the mobile device such that a front screen of the mobile device is facing up;
look down at the front screen; and
make an expression that the user would not normally make in a photo.

7. A mobile device having a processor and memory, the mobile device being configured to perform operations comprising:
prompting a user to submit a non-standard selfie;
receiving the non-standard selfie;
determining whether an expression in the non-standard selfie meets a required degree of uniqueness, wherein the required degree of uniqueness comprises a minimum variance; and
in response to determining that the expression in the non-standard selfie meets the required degree of uniqueness, setting the non-standard selfie as an authentication password.

8. The mobile device of claim 7, the mobile device being configured to perform operations further comprising:
prompting the user to submit a standard selfie; and
receiving the standard selfie from the user,
wherein determining whether the expression in the selfie meets the required degree of uniqueness comprises:
comparing the expression in the non-standard selfie to the expression in the standard selfie; and
determining a variance between the expression in the non-standard selfie and the expression in the standard selfie.

9. The mobile device of claim 7, wherein the memory stores selfies that are submitted by the user, and wherein determining whether the expression in the non-standard selfie meets the required degree of uniqueness comprises:
comparing the expression in the non-standard selfie to expressions in previously submitted selfies; and
determining a variance between the expression in the non-standard selfie and the expressions in the previously submitted selfies.

10. The mobile device of claim 7, wherein determining whether the expression in the non-standard selfie meets the required degree of uniqueness comprises:
accessing at least one photo gallery containing pictures of the user;
comparing the expression in the non-standard selfie to expressions in the pictures of the user contained in the at least one photo gallery; and
determining a variance between the expression in the non-standard and the expressions in the pictures of the user contained in the at least one photo gallery.

11. The mobile device of claim 7, the mobile device being configured to perform operations further comprising prompting the user to provide a different non-standard selfie, in response to determining that the non-standard selfie does not meet the required degree of uniqueness.

12. The mobile device of claim 7, wherein prompting a user to submit a non-standard selfie comprises displaying instructions to the user to:
point the mobile device such that a front screen of the mobile device is facing up;
look down at the front screen; and
make an expression that the user would not normally make in a photo.

13. The mobile device of claim 7, wherein the operations performed by the mobile device are performed by an operating system of the mobile device.

14. A non-transitory, computer-readable storage medium comprising instructions that when executed by a computer, cause the computer to perform:
prompting a user to submit a non-standard selfie;
receiving the non-standard selfie;
determining whether an expression in the non-standard selfie meets a required degree of uniqueness; and
in response to determining that the expression in the non-standard selfie meets the required degree of uniqueness, setting the non-standard selfie as an authentication password.

15. The non-transitory, computer-readable storage medium of claim 14, wherein the computer further performs:
prompting the user to submit a standard selfie; and
receiving the standard selfie from the user,
wherein determining whether the expression in the selfie meets the required degree of uniqueness comprises:
comparing the expression in the non-standard selfie to the expression in the standard selfie; and
determining a variance between the expression in the non-standard selfie and the expression in the standard selfie.

16. The non-transitory, computer-readable storage medium of claim 14, wherein determining whether the expression in the non-standard selfie meets the required degree of uniqueness comprises:
comparing the expression in the non-standard selfie to expressions in previously submitted selfies; and
determining a variance between the expression in the non-standard selfie and the expressions in the previously submitted selfies.

17. The non-transitory, computer-readable storage medium of claim 14, wherein determining whether the expression in the non-standard selfie meets the required degree of uniqueness comprises:
accessing at least one photo gallery containing pictures of the user;
comparing the expression in the non-standard selfie to expressions in the pictures of the user contained in the at least one photo gallery; and
determining a variance between the expression in the non-standard selfie and the expressions in the pictures of the user contained in the at least one photo gallery.

18. The non-transitory, computer-readable storage medium of claim 14, wherein the computer further performs prompting the user to provide a second, different non-standard selfie, in response to determining that the non-standard selfie does not meet the required degree of uniqueness.

19. The non-transitory, computer-readable storage medium of claim 14, wherein a mobile device is configured to receive the non-standard selfie, and wherein prompting a user to submit a non-standard selfie comprises displaying instructions to the user to:
point the mobile device such that a front screen of the mobile device is facing up;
look down at the front screen; and
make an expression that the user would not normally make in a photo.

20. The non-transitory, computer-readable storage medium of claim 14, wherein the required degree of uniqueness comprises a minimum variance, and wherein the expression in the non-standard selfie meets the required degree of uniqueness when the variance between the expression in the non-standard selfie and the expressions in the pictures of the user contained in the at least one photo gallery is greater than the minimum variance.
